(19) United States
(12) Patent Application Publication
(10) Pub. No.: US 2017/0371418 A1
(43) Pub. Date: Dec. 28, 2017

(54) METHOD FOR RECOGNIZING MULTIPLE USER ACTIONS ON BASIS OF SOUND INFORMATION

(71) Applicant: UNIVERSITY-INDUSTRY COOPERATION GROUP OF KYUNG HEE UNIVERSITY, Seoul (KR)

(72) Inventor: Oh Byung KWON, Seoul (KR)

(21) Appl. No.: 15/525,810

(22) PCT Filed: Nov. 9, 2015
(86) PCT No.: PCT/KR2015/012016

§ 371 Date: May 10, 2017

(30) Foreign Application Priority Data
Nov. 18, 2014 (KR) 10-2014-0160761

(51) Int. Cl. G06F 3/01; G01N 29/36; G06T 7/20; H04W 4/02

(52) U.S. Cl. CPC G06F 3/017; H04W 4/02; G01N 29/36; G06T 7/20

(57) ABSTRACT

The present invention relates to a method for recognizing multiple user actions and, more particularly, provided is a method capable of recognizing multiple user actions from a collected sound source when multiple actions are performed in a specific space, and accurately determining a user situation from the recognized multiple user actions.

### TECHNICAL FIELD

The present disclosure relates to a method of recognizing multiple user actions. More particularly, the present disclosure relates to a method of recognizing multiple user actions based on collected sounds when multiple actions are performed in a specific space and accurately determining a user situation based on the multiple user actions recognized.

### BACKGROUND ART

Recognition of user actions is regarded as an important factor in determining user situations in the everyday life of a user. The determination of user situations may be used in a variety of services that work in concert with the ubiquitous environment to, for example, control the environment of a place in which the user is located, provide a medical service, or recommend a product suitable for the user.

Conventional methods used to recognize user actions include a location-based recognition method, an action-based recognition method, a sound-based recognition method, and the like.

The location-based recognition method recognizes user actions based on places in which a user is located, using a global positioning system (GPS) module attached to a terminal that the user carries or a user detection sensor, such as an infrared (IR) sensor or a heat sensor, disposed in a place in which the user is located. That is, user action recognition is performed based on a specific place in which the user is located, so that an action that can be performed in the specific place is recognized as being a user action. However, since a variety of actions may be performed in the same place, it may be difficult to accurately recognize the user actions using conventional location-based recognition methods.

The action-based recognition method captures user images using a camera, extracts continuous motions or gestures from the captured user images, and recognizes the extracted continuous motions or gestures as user actions. However, the action-based recognition method has the problem of privacy violation, since user images are captured. In addition, it may be difficult to accurately recognize user actions based on continuous motions or gestures extracted from the user images.

The conventional sound-based recognition method collects sounds produced in a place in which a user is located using a microphone carried by the user or disposed in the place in which the user is located and recognizes user actions based on the collected sounds. The sound-based recognition method is performed based on sound information. The sound-based recognition method searches a database for a reference sound most similar to the sound information and recognizes an action mapped to the most similar sound as a user action. In the conventional sound-based recognition method, an action mapped to the most similar reference sound based on the sound information is recognized as being the user action. When sounds corresponding to multiple actions are mixed due to a plurality of users respectively performing multiple actions or a single user simultaneously or sequentially performing multiple actions, the multiple actions cannot be recognized, which is problematic.

### DISCLOSURE

### Technical Problem

Accordingly, the present disclosure has been made in consideration of the above-described problems occurring in the related art, and the present disclosure proposes a method of recognizing multiple user actions from collected sounds when multiple actions are performed in a specific place.

The present disclosure also proposes a method of recognizing multiple user actions from a starting sound pattern corresponding to a starting portion of collected sounds and an ending sound pattern corresponding to an ending portion of the collected sounds.

The present disclosure also proposes a method of accurately recognizing multiple user actions from collected sounds by referring to information regarding a place, in which the sounds are collected, and removing exclusive actions from the collected sounds, the exclusive actions being determined to not occur based on the place information.

### Technical Solution

According to an aspect of the present disclosure, provided is a method of recognizing multiple user actions. The method may include: collecting sounds in a place in which a user is located; calculating starting similarities between a starting sound pattern of the collected sounds and reference sound patterns stored in a database and ending similarities between an ending sound pattern of the collected sounds and the reference sound patterns stored in the database; selecting starting candidate reference sound patterns and ending candidate reference sound patterns, same as the starting sound pattern and the ending sound pattern of the collected sounds, from among the reference sound patterns, based on the starting similarities and the ending similarities; and recognizing multiple user actions based on the starting candidate reference sound patterns, the ending candidate reference sound patterns, and user location information.

The method may further include: determining increasing zones, increasing by a size equal to or greater than a threshold size in the collected sounds; and determining the number of multiple actions that produce the collected sounds, based on the number of the increasing zones.

The step of selecting the starting candidate reference sound patterns and the ending candidate reference sound patterns may include: determining exclusive reference sound patterns, not occurring in the place, from among the starting candidate reference sound patterns or the ending candidate reference sound patterns, based on the user location information; and determining final candidate reference sound patterns by removing the exclusive reference sound patterns from the starting candidate reference sound patterns or the ending candidate reference sound patterns. The multiple user actions may be recognized based on the final candidate reference sound patterns and the user location information.

When the number of the increasing zones or the decreasing zones is determined to be 2, the step of recognizing the multiple user actions may include: generating a candidate combination sound by combining a single starting candidate reference sound pattern from among the final candidate reference sound patterns and a single ending candidate reference sound pattern from among the final candidate reference sound patterns; determining a final candidate combination sound, most similar to the collected sounds, by comparing similarities between the candidate combination sound and the collected sounds; and recognizing multiple actions mapped to the starting candidate reference sound pattern and the ending candidate reference sound pattern of the final candidate combination sound as the multiple user actions.

When the number of the increasing zones is determined to be 2, the step of recognizing the multiple user actions may include: determining whether or not a final candidate reference sound pattern from among the final candidate reference sound patterns of the starting candidate reference sound patterns is same as a final candidate reference sound pattern from among the final candidate reference sound patterns of the ending candidate reference sound patterns; when the same final candidate reference sound pattern is present, determining the same final candidate reference sound pattern as a first final sound pattern; determining a second final sound pattern by comparing similarities between subtracted sounds, produced by removing the first final sound pattern from the collected sounds, and the reference sound patterns stored in the database; and recognizing actions mapped to the first final sound pattern and the second final sound pattern as the multiple user actions.

According to another aspect of the present disclosure, a method of recognizing multiple user actions may include: collecting sounds in a place in which a user is located; calculating starting similarities between a starting sound pattern of the collected sounds and reference sound patterns stored in a database and ending similarities between an ending sound pattern of the collected sounds and the reference sound patterns stored in the database; determining starting candidate reference sound patterns, same as the starting sound pattern, from among the reference sound patterns, based on the starting similarities, and ending candidate reference sound patterns, same as the ending sound pattern, from among the reference sound patterns, based on the ending similarities; determining whether or not a candidate reference sound pattern from among the starting candidate reference sound patterns is same as a candidate reference sound pattern from among the ending candidate reference sound patterns; when the same candidate reference sound pattern is present, determining the same candidate reference sound pattern as a first final sound pattern and determining remaining final sound patterns using the first final sound pattern; and recognizing user actions mapped to the first final sound pattern and the remaining final sound patterns as multiple user actions.

The method may further include: determining increasing zones, increasing by a size equal to or greater than a threshold size, in the collected sounds; and determining the number of multiple actions that produce the collected sounds, based on the number of the increasing zones.

When the number of the increasing zones is determined to be 2, the step of recognizing the multiple user actions may include: when the same candidate reference sound pattern is present, determining the same candidate reference sound pattern as the first final sound pattern; determining a second final sound pattern by comparing similarities between subtracted sounds, produced by removing the first final sound pattern from the collected sounds, and the reference sound patterns stored in the database; and recognizing actions mapped to the first final sound pattern and the second final sound pattern as the multiple user actions.

When the same candidate reference sound pattern is not present and the number of the increasing zones is determined to be 2, the step of recognizing the multiple user actions may include: generating a candidate combination sound by combining the starting candidate reference sound patterns and the ending candidate reference sound patterns; determining a final candidate combination sound, most similar to the collected sounds, from among the candidate combination sound by comparing similarities between the candidate combination sound and the collected sounds; and recognizing actions mapped to the starting candidate reference sound patterns and the ending candidate reference sound patterns of the final candidate combination sound as the multiple user actions.

The step of determining the starting candidate reference sound patterns and the ending candidate reference sound patterns may include: determining exclusive reference sound patterns, not occurring in the place, from among the candidate reference sound patterns, based on the user location information; and determining final candidate reference sound patterns by removing the exclusive reference sound patterns from the starting candidate reference sound patterns or the ending candidate reference sound patterns.

According to an aspect of the present disclosure, a method of determining a user situation may include: collecting sounds and user location information in a place in which a user is located; calculating starting similarities between a starting sound pattern of the collected sounds and reference sound patterns stored in a database and ending similarities between an ending sound pattern of the collected sounds and the reference sound patterns stored in the database; selecting starting candidate reference sound patterns and ending candidate reference sound patterns, same as the starting sound pattern and the ending sound pattern, from among the reference sound patterns, based on the starting similarities and the ending similarities; determining a first final sound pattern and a second final sound pattern, producing the collected sounds, from among the starting candidate reference sound patterns or the ending candidate reference sound patterns, by comparing combined sound patterns, produced from the starting candidate reference sound patterns and the ending candidate reference sound patterns, with the collected sounds; and determining a user situation based on a combination of sound patterns, produced from the first final sound pattern and the second final sound pattern, and the user location information.

The method may further include: determining increasing zones, increasing by a size equal to or greater than a threshold size, in the collected sounds; and determining the number of multiple actions that produce the collected sounds, based on the number of the increasing zones.

The step of selecting the starting candidate reference sound patterns and the ending candidate reference sound patterns may include: determining exclusive reference sound patterns, not occurring in the place, from among the starting candidate reference sound patterns or the ending candidate reference sound patterns, based on the user location information; and removing the exclusive reference sound patterns from the starting candidate reference sound patterns or the ending candidate reference sound patterns.

When the number of the increasing zones is determined to be 2, the step of determining the user situation may include: generating a candidate combination sound by combining a single candidate reference sound pattern from among the starting candidate reference sound patterns and a single candidate reference sound pattern from among the ending candidate reference sound patterns; determining a final candidate combination sound, most similar to the collected sounds, from the candidate combination sound by comparing similarities between the candidate combination sound and the collected sounds; and determining the user situation based on the multiple actions corresponding to a combination of the first final sound pattern and the second final sound pattern of the final candidate combination sound.

When the number of the increasing zones is determined to be 2, the step of determining the user situation may include: determining whether or not a final candidate reference sound pattern from among the starting candidate reference sound patterns is same as a final candidate reference sound pattern from among the ending candidate reference sound patterns; determining the same final candidate reference sound pattern as a first final sound pattern; determining a second final sound pattern by comparing similarities between subtracted sounds, produced by removing the first final sound pattern from the collected sounds, and the reference sound patterns stored in the database; and determining the user situation based on the multiple actions corresponding to a combination of the first final sound pattern and the second final sound pattern.

### Advantageous Effects

The method of recognizing multiple user actions according to the present disclosure has a variety of effects as follows:

First, the method of recognizing multiple user actions according to the present disclosure can recognize multiple actions that a user simultaneously or sequentially performs, based on a starting sound pattern corresponding to a starting portion of collected sounds and an ending sound pattern corresponding to an ending portion of the collected sounds.

Second, the method of recognizing multiple user actions according to the present disclosure can determine a first user action mapped to a starting sound pattern or an ending sound pattern of collected sounds, according to whether or not any one of candidate reference sound patterns for the starting sound pattern is the same as any one of candidate reference sound patterns for the ending sound pattern, and then accurately determine remaining user actions except for the first user action.

Third, the method of recognizing multiple user actions according to the present disclosure can accurately determine user actions by selecting candidate reference sound patterns, from which user actions can be recognized, based on information regarding collected sounds, and then selecting final candidate reference sound patterns based on information regarding a place in which the user is located.

Fourth, the method of recognizing multiple user actions according to the present disclosure can recognize user actions based on information regarding sounds collected in a place in which the user is located, as well as information regarding the place. It is thereby possible to protect the privacy of the user while accurately determining multiple user actions without requiring the user to additionally input specific pieces of information.

Fifth, the method of recognizing multiple user actions according to the present disclosure can accurately determine a user situation by combining multiple user actions that are simultaneously or sequentially performed by recognizing the multiple user actions from collected sounds.

### DESCRIPTION OF DRAWINGS

FIG. 1 is a function block diagram illustrating a user action recognition system according to an exemplary embodiment of the present disclosure;

FIG. 2 is a function block diagram illustrating a user situation determination system according to an exemplary embodiment of the present disclosure;

FIG. 3 is a function block diagram illustrating a specific example of the action number determiner according to the present disclosure;

FIG. 4 is a function block diagram illustrating a specific example of the multiple action recognizer according to the present disclosure;

FIG. 5 is a function block diagram illustrating another specific example of the multiple action recognizer according to the present disclosure;

FIG. 6 is a flowchart illustrating a method of recognizing multiple user actions according to an exemplary embodiment of the present disclosure;

FIG. 7 is a graph illustrating an example in which collected sounds are divided based on an increasing zone or a decreasing zone;

FIG. 8 illustrates an example of the database according to the present disclosure;

FIG. 9 is a flowchart illustrating an exemplary step of selecting a candidate reference sound according to the present disclosure;

FIG. 10 is a flowchart illustrating an exemplary step of recognizing multiple user actions according to the present disclosure;

FIG. 11 is a flowchart illustrating another exemplary step of recognizing multiple user actions according to the present disclosure;

FIG. 12 is a graph illustrating an exemplary step of recognizing multiple user actions;

FIG. 13 is a graph illustrating an exemplary method of recognizing multiple user actions when collected sounds include sound patterns corresponding to three or more user actions;

FIG. 14 is a flowchart illustrating a method of recognizing user situations according to the present disclosure;

FIG. 15 illustrates an exemplary database containing combinations of sound patterns and user situations mapped to the combinations of sound patterns.

### MODE FOR INVENTION

Hereinafter, a method of recognizing multiple user actions according to the present disclosure will be described in detail with reference to the accompanying drawings.

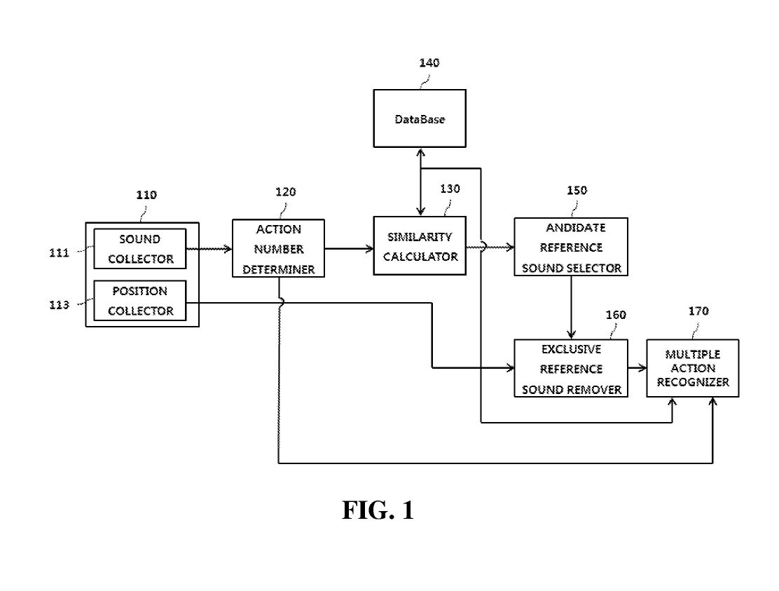

FIG. 1 is a function block diagram illustrating a user action recognition system according to an exemplary embodiment of the present disclosure.

Described in detail with reference to FIG. 1, an information collector 110 collects information to be used to determine user actions in a place in which a user is located. The information collector 110 includes a sound collector 111 and a position collector 113. The sound collector 111 collects sounds in the place in which the user is located, while the position collector 113 collects position information regarding the place in which the user is located. The sound collector 111 may be a microphone, while the position collector 113 may be a global positioning system (GPS) module attached to a terminal carried by the user, an infrared (IR) sensor or a heat sensor disposed in the place in which the user is located, or the like. Sound information collected thereby may be a formant, a pitch, intensity, and the like, which can represent the characteristics of the collected sounds. Various types of sound information may be used depending on fields to which the present disclosure is applied. Such various types of sound information belong to the scope of the present disclosure.

An action number determiner 120 determines increasing zones or decreasing zones that increase or decrease by a size equal to or greater than a threshold size by measuring the sizes of the collected sounds and determines the number of actions that produce the collected sounds, based on the number of the increasing zones or the decreasing zones. In addition, the action number determiner 120 divides a first increasing zone in the collected sounds as a starting sound pattern (PRE-P) and divides a last decreasing zone in the collected sounds as an ending sound pattern (POST-P).

A similarity calculator 130 calculates similarities between the starting sound pattern and the reference sound patterns and between the ending sound pattern and the reference sound patterns by comparing the starting sound pattern and the ending sound pattern with the reference sound patterns stored in a database 140. The similarities may be calculated by comparing sound information, corresponding to at least one of the formant, pitch, and intensity of the starting sound pattern or the ending sound pattern, with sound information, corresponding to at least one of the formant, pitch, and intensity of each of the reference sound patterns.

A candidate reference sound selector 150 selects reference sound patterns, the same as the starting sound pattern and the ending sound pattern, as candidate reference sound patterns, based on the similarities between the starting sound pattern and the reference sound patterns or between the ending sound pattern and the reference sound patterns. The candidate reference sound patterns, the same as the starting sound pattern, are referred to as starting candidate reference sound patterns, while the candidate reference sound patterns, the same as the ending sound pattern, are referred to as ending candidate reference sound patterns.

An exclusive reference sound remover 160 determines exclusive reference sound patterns, not occurring in the place in which the user is located, from among the selected candidate reference sound patterns, based on the collected position information, and determines final candidate reference sound patterns by removing the determined exclusive reference sound patterns from the selected candidate reference sound patterns. For example, the exclusive reference sound remover 160 determines the final candidate reference sound patterns of the starting candidate reference sound patterns by removing the exclusive reference sound patterns from the starting candidate sound patterns and determines the final candidate reference sound patterns of the ending candidate reference sound patterns by removing the exclusive reference sound patterns from the ending candidate sound patterns. The database 140 may contain the reference sound patterns and user action information and place information mapped to the reference sound patterns. Here, the user action information is information regarding user actions corresponding to the reference sound patterns, and the place information is information regarding places in which the reference sound patterns may occur.

A multiple action recognizer 170 recognizes multiple user actions based on the final candidate reference sound patterns of the starting candidate reference sound patterns and the final candidate reference sound patterns of the ending candidate reference sound patterns.

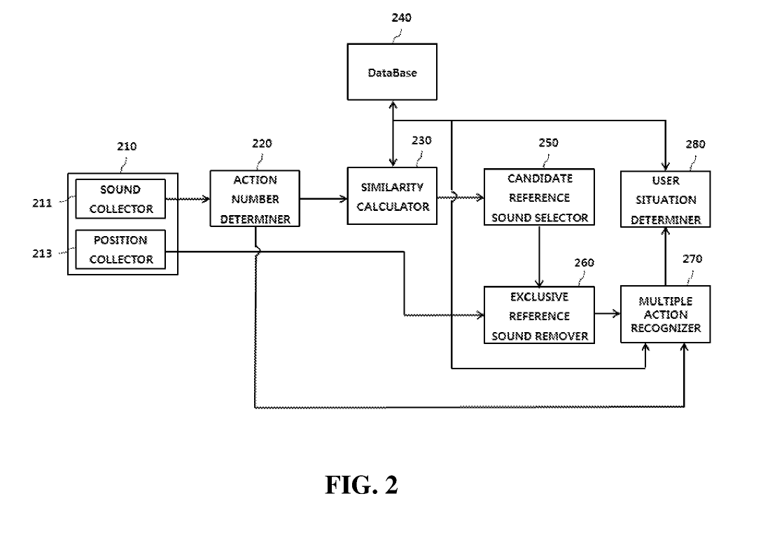

FIG. 2 is a function block diagram illustrating a user situation determination system according to an exemplary embodiment of the present disclosure.

An information collector 210, an action number determiner 220, a similarity calculator 230, a database 240, a candidate reference sound selector 250, and an exclusive reference sound remover 260, illustrated in FIG. 1, operate in the same manner as the information collector 110, the action number determiner 120, the similarity calculator 130, the database 140, the candidate reference sound selector 150, and the exclusive reference sound remover 160, as described above with reference to FIG. 1, and detailed descriptions thereof will be omitted.

A multiple action recognizer 270 determines a final starting sound pattern and a final ending sound pattern from the starting candidate reference sound patterns or the ending candidate reference sound patterns, the collected sounds being composed of the final starting sound pattern and the final ending sound pattern, by comparing combined sound patterns, generated from the starting candidate reference sound patterns and the ending candidate reference sound patterns, with the collected sounds.

A user situation determiner 280 searches the database 240 for a user situation corresponding to a combination of sound patterns and user position information, based on the combination of sound patterns generated from the final starting sound pattern and the final ending sound pattern and the user position information, and determines the searched user situation as the current situation of the user. The database 240 may contain user situations mapped to the combination of sound patterns.

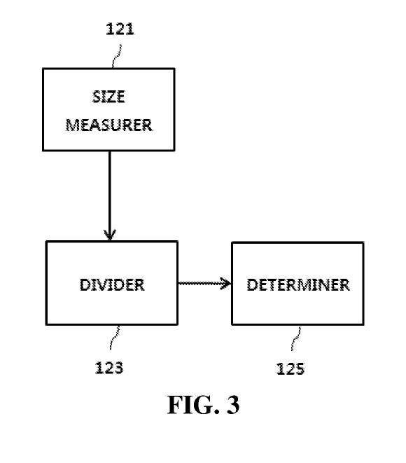

FIG. 3 is a function block diagram illustrating a specific example of the action number determiner according to the present disclosure.

Described in greater detail with reference to FIG. 3, a size measurer 121 measures the size of information regarding the collected sounds, while a divider 123 divides collected sounds by determining an increasing zone that increases by a size equal to or greater than a threshold size and a decreasing zone that decreases by a size equal to or greater than the threshold size, based on the size of the measured sound information. The divider 123 divides a first increasing zone in the collected sounds as a starting sound pattern and a last decreasing zone in the collected sounds as an ending sound pattern.

A determiner 125 determines the number of user actions that produce the collected sounds, based on the number of the increasing zones or the number of the decreasing zones determined by the divider 123.

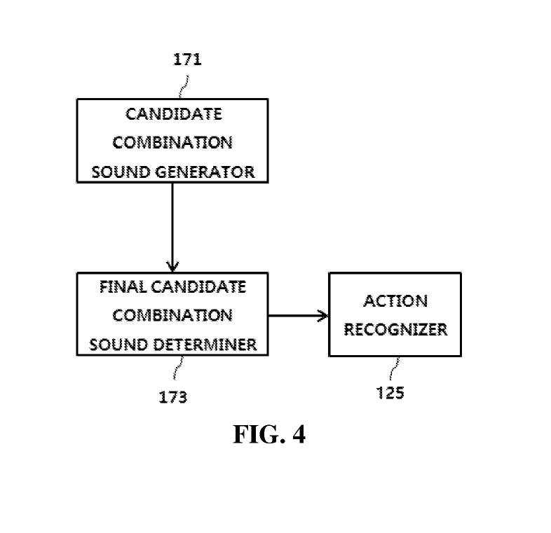

FIG. 4 is a function block diagram illustrating a specific example of the multiple action recognizer according to the present disclosure.

Described in greater detail with reference to FIG. 4, when the number of actions producing collected sounds is determined to be 2, a candidate combination sound generator 171 generates a candidate combination sound consisting of a single starting candidate reference sound pattern from among the starting candidate reference sound patterns, from which exclusive reference sounds are removed, and a single ending candidate reference sound pattern from among the ending candidate reference sound patterns, from which exclusive reference sounds are removed.

A final candidate combination sound determiner 173 determines the candidate combination sound, most similar to the collected sounds, from among the candidate combination sound, to be a final candidate combination sound, by comparing similarities between the candidate combination sound and the collected sounds.

An action recognizer 125 searches the database 140 and 240 for actions mapped to the starting candidate reference sound patterns and the ending candidate reference sound patterns of the candidate combination sound and recognizes the searched actions as multiple user actions.

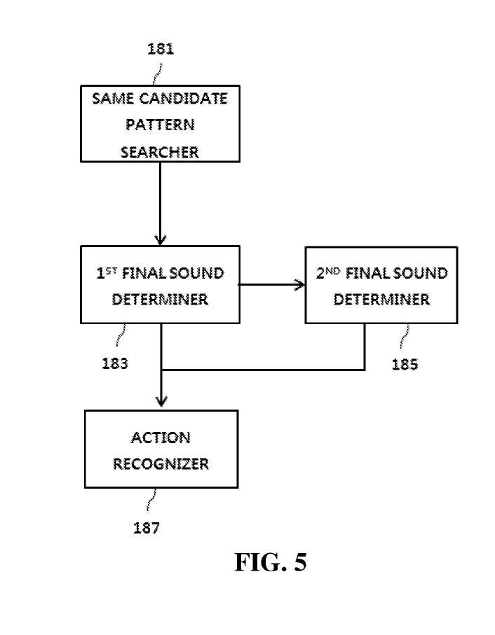

FIG. 5 is a function block diagram illustrating another specific example of the multiple action recognizer according to the present disclosure.

Described in greater detail with reference to FIG. 5, provided is a same candidate pattern searcher 181. When the number of actions producing collected sounds is determined to be 2, the same candidate pattern searcher 181 performs searches to determine whether or not a final candidate reference sound pattern of the starting candidate reference sound patterns is the same as a final candidate reference sound pattern of the ending candidate reference sound patterns.

When the same candidate reference sound pattern is present, a first final sound determiner 183 determines the same candidate reference sound pattern to be a first final sound pattern, and a second final sound determiner 183 determines a reference sound pattern having a highest similarity to be a second final sound pattern by comparing similarities between subtracted sounds, produced by subtracting the first final sound pattern from the collected sounds, and reference sound patterns stored in the database 140 and 240.

An action recognizer 187 recognizes actions mapped to the first final sound pattern and the second final sound pattern in the database 240 to be multiple user actions.

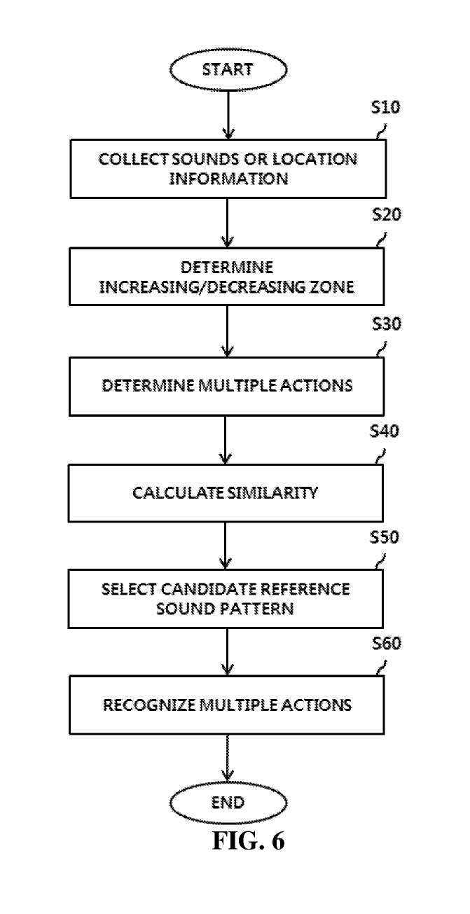

FIG. 6 is a flowchart illustrating a method of recognizing multiple user actions according to an exemplary embodiment of the present disclosure.

Described in greater detail with reference to FIG. 6, in S10, sounds and position information are collected in a place in which a user is located. In S20, in the collected sounds, increasing zones or decreasing zones that increase or decrease by a size equal to or greater than a threshold size are determined. Here, each increasing zone or decreasing zone is determined by measuring the size of information collected sounds, and then, based on the size of information regarding the collected sounds, monitoring a zone increasing or decreasing by the size equal to or greater than the threshold size for a preset period of time. A zone between the increasing zone or the decreasing zone and the next increasing zone or the next decreasing zone is divided as an increasing zone or a decreasing zone. A first increasing zone occurring in the collected sounds is selected as a starting sound pattern, while a last decreasing zone occurring in the collected sounds is selected as an ending sound pattern.

In S30, the number of multiple actions producing the collected sounds is determined, based on the number of the increasing zones or decreasing zones. Typically, when the user additionally performs an action while performing another action, the size of the information regarding the collected sounds suddenly increases. When the user stops performing an action while performing multiple actions, the size of the information regarding the collected sounds suddenly decreases. Based on this fact, the number of multiple actions producing the collected sounds is determined from the number of the increasing zones or decreasing zone.

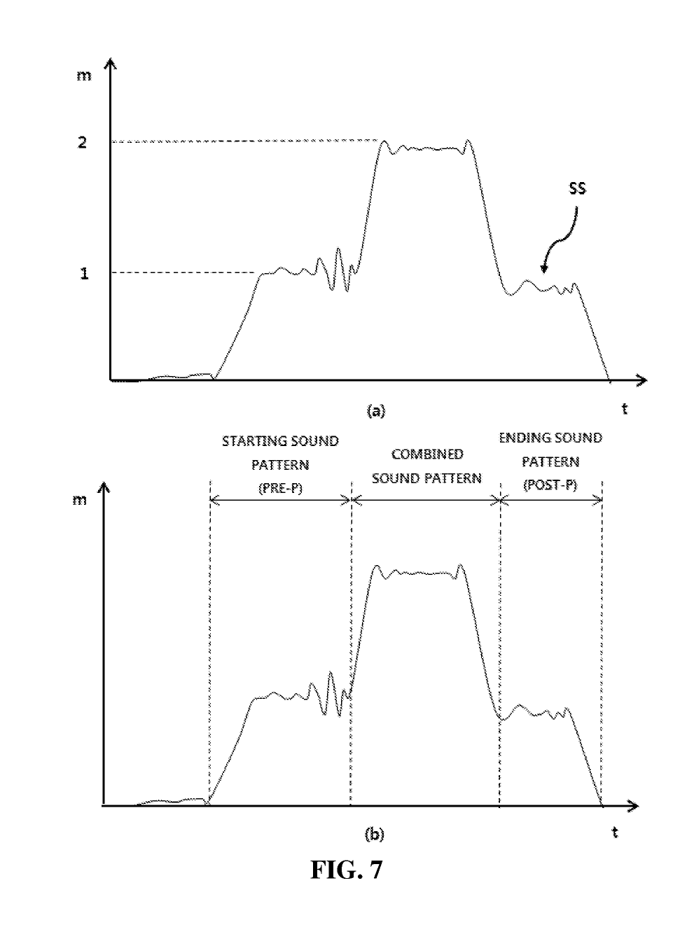

FIG. 7 is a graph illustrating an example in which collected sounds are divided based on an increasing zone or a decreasing zone.

First, referring to FIG. 7 (a), an increasing zone or a decreasing zone that increases or decreases by a size equal to or greater than a threshold size for a preset period of time is determined by measuring the size of collected sounds. A zone, in which the size of information regarding the collected sounds increases or decreases by a size equal to or greater than a threshold size, may be determined to be an increasing zone or a decreasing zone. In FIG. 7 (a), first, a single action in an increasing zone, in which the size of the information regarding the collected sounds increases by a size equal to or greater than the threshold size, forms a sound. Second, another single action added to another increasing zone, in which the size of the information regarding the collected sounds increases by a size equal to or greater than the threshold size, forms another sound. Accordingly, the number of multiple actions producing the collected sounds can be determined from the number of the increasing zones.

Referring to FIG. 7 (b), a zone, in which the size of the information regarding the collected sounds starts increasing by a size equal to or greater than the threshold size, is determined and divided as a unit increasing zone, while a zone, in which the size of the information regarding the collected sounds starts decreasing by a size equal to or greater than the threshold size, is divided as a unit decreasing zone. In the unit increasing zone or unit decreasing zone in which the size of the information regarding the collected sounds increases or decreases, a zone, except for the starting sound pattern and the ending sound pattern, is divided as a combined sound pattern.

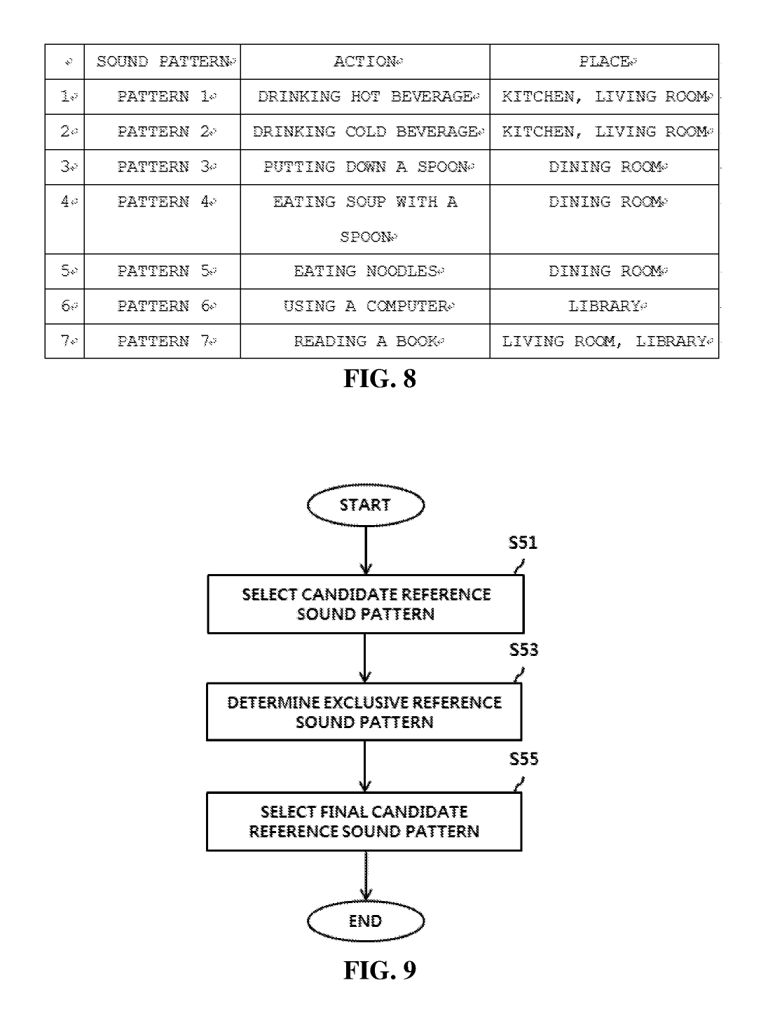

Returning to FIG. 6, in S40, the starting similarities between a starting sound pattern of the collected sounds and reference sound patterns stored in the database are calculated, and the ending similarities between an ending sound pattern of the collected sounds and the reference sound patterns stored in the database are calculated. FIG. 8 illustrates an example of the database. As illustrated in FIG. 8, the database contains information regarding sound patterns, actions corresponding to the sound patterns, and places in which the actions may occur. Here, the information regarding sound patterns may be information regarding reference sound patterns, for example, information regarding a formant, a pitch, intensity, and the like.

Types of information regarding reference sound patterns stored in the database are the same types of information regarding the collected sounds. Similarities between the collected sounds and the information regarding the reference sound patterns are calculated, according to types of information, such as a formant, a pitch, and intensity. An example of a method of calculating similarities S_{SI} may be represented by Formula 1.

$${S}_{SI} = {Q}_{i = 1}^{n} \frac{\vert {GI}_{i} - {SI}_{i} \vert}{{SI}_{i}} \qquad [ Formula 1 ]$$

In Formula 1, SIᵢ indicates an information type i regarding reference sound patterns, GIᵢ indicates an information type i regarding collected sounds, the same type as the information type regarding reference sound patterns, and n indicates the number of information types regarding reference sound patterns or the number of information types regarding the collected sounds.

In S50, starting candidate reference sound patterns and ending candidate reference sound patterns are selected from among the reference sound patterns based on the calculated similarities S_{SI}. Specifically, the reference sound pattern, the similarities thereof to the starting sound pattern being equal to or higher than a threshold similarity, are selected as the starting candidate reference sound patterns, and the reference sound patterns, the similarities thereof to the ending sound pattern being equal to or higher than a threshold similarity, are selected as the ending candidate reference sound patterns. Based on the calculated similarities S_{SI}, reference sound patterns having an upper threshold number and a higher similarity to the starting sound pattern may be selected as the starting candidate reference sound patterns, or reference sound patterns having an upper threshold number and a higher similarity to the ending sound pattern may be selected as the ending candidate reference sound patterns.

In S60, multiple user actions are recognized from the collected sounds based on the starting candidate reference sound patterns, the ending candidate reference sound patterns, and user location information.

FIG. 9 is a flowchart illustrating an exemplary step of selecting a candidate reference sound according to the present disclosure.

Described in greater detail with reference to FIG. 9, S51 is a step of selecting specific reference sound patterns, the same as the starting sound pattern and the ending sound pattern, as the starting candidate reference sound patterns and the ending candidate reference sound patterns by comparing the starting sound pattern and the ending sound pattern of the collected sounds with the reference sound patterns in the database.

In S53, reference sound patterns, not occurring in the place in which the user is located, from among the starting candidate reference sound patterns or the ending candidate reference sound patterns, are determined to be exclusive reference sound patterns, based on the user location information and the place information of the reference sound patterns stored in the database. For example, when pattern 1, pattern 2, pattern 3, and pattern 7 are selected as the starting candidate reference sound patterns, the user location information may be determined to be a dining room. In this case, pattern 7 is determined to be an exclusive reference sound pattern not occurring in the place in which the user is located, since the place information mapped to pattern 7 indicates a living room and a library.

In S55, final candidate reference sound patterns are determined by removing the exclusive reference sound patterns from the starting candidate reference sound patterns or the ending candidate reference sound patterns.

Preferably, in the step of recognizing the multiple user actions, the multiple user actions are recognized based on the final candidate reference sound pattern, produced by removing the exclusive reference sound patterns from candidate reference sound patterns, and user location information.

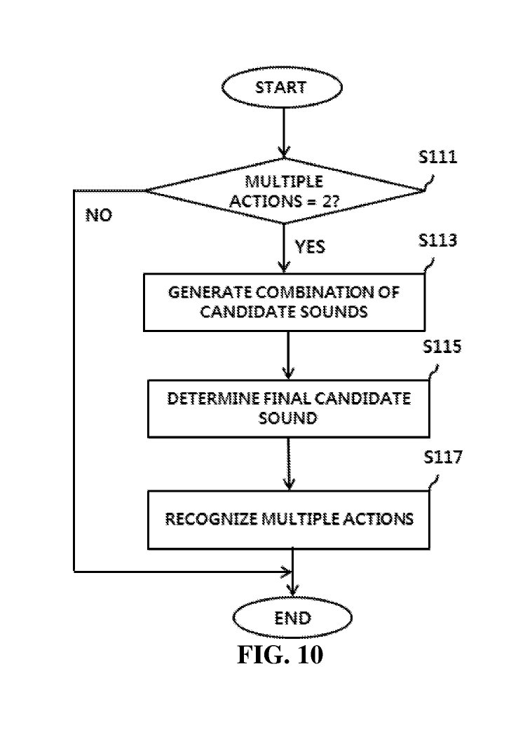

FIG. 10 is a flowchart illustrating an exemplary step of recognizing multiple user actions according to the present disclosure.

Described in greater detail with reference to FIG. 10, in S111, it is determined whether or not two increasing zones present are present in the collected sounds. In S113, when the number of user actions is determined to be 2, based on the number of the increasing zones, a candidate combination sound is generated by combining a single starting candidate reference sound pattern from among the final candidate reference sound patterns and a single ending candidate reference sound pattern from among the final candidate reference sound patterns.

In S115, a final candidate combination sound most similar to the collected sounds is determined by comparing similarities between the candidate combination sound and the collected sounds. Here, the similarities between the candidate combination sound and the collected sounds are calculated by combing the similarities of pieces of information regarding the candidate combination sound, according to the types of information regarding the collected sounds, as described above with reference to Formula 1.

In S117, the database is searched for multiple actions mapped to the starting candidate reference sound patterns and the ending candidate reference sound patterns of the combination of final candidate sounds, and the searched actions are recognized as multiple user actions.

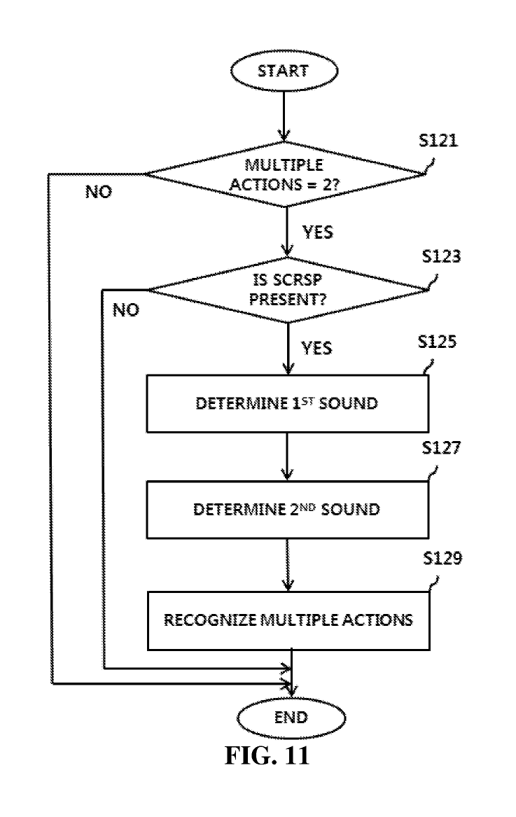

FIG. 11 is a flowchart illustrating another exemplary step of recognizing multiple user actions according to the present disclosure.

Described in greater detail with reference to FIG. 11, in S121, it is determined whether or not the number of increasing zones in the collected sounds is 2. In S123, it is determined whether or not any one of the final candidate reference sound patterns of the starting candidate reference sound patterns is the same as any one of the final candidate reference sound patterns of the ending candidate reference sound patterns. When the same candidate reference sound pattern (SCRSP) is present, in S125, the same candidate reference sound pattern is determined to be a first final sound pattern.

In S127, a second final sound pattern is determined by comparing similarities between subtracted sounds, produced by subtracting the first final sound pattern from the collected sounds, and reference sound patterns stored in the database. The similarities between the subtracted sounds and the reference sound patterns may be calculated by combining the similarities of pieces of information regarding the reference sound patterns, according to the types of information regarding the subtracted sounds, as described above with reference to Formula 1.

In S129, the database is searched for actions mapped to the first final sound pattern and the second final sound pattern, and the searched actions are recognized as multiple user actions.

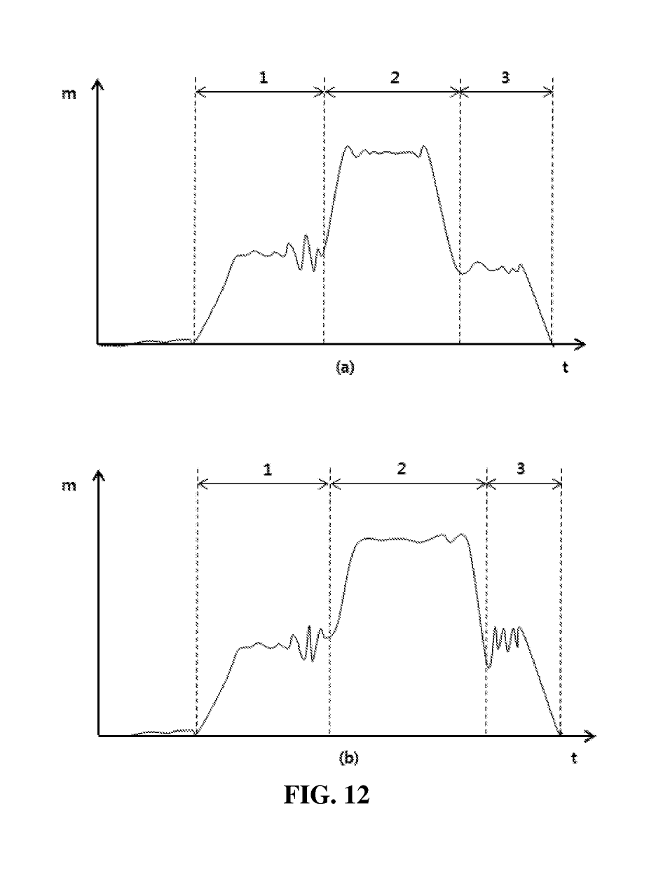

FIG. 12 is a graph illustrating an exemplary step of recognizing multiple user actions.

First, referring to FIG. 12 (a), when the number of increasing zones present in the collected sounds is 2, the collected sounds are divided into a starting sound pattern, an ending sound pattern, and a combined sound pattern. When a1 and a2 are selected as final starting candidate reference sound patterns of the starting sound pattern and b1 and b2 are selected as final ending candidate reference sound patterns of the ending sound pattern, a candidate combination sound {(a1, b1), (a1, b2), (a2, b1), (a2, b2)} are produced by combining one of final starting candidate reference sound patterns and one of final ending candidate reference sound patterns. Here, a1, a2, b1, and b2 are reference sound patterns stored in the database.

The most similar final candidate combination sound (a1, b2) are determined by comparing similarities between the candidate combination sound and the combined sound patterns of the collected sounds. Actions mapped to (a1, b2) are regarded as being multiple user actions.

Referring to FIG. 12 (b), when the number of increasing zones present in the collected sounds is 2, the collected sounds are divided into a starting sound pattern, an ending sound pattern, and a combined sound pattern. When (a1, a2) are selected as final starting candidate reference sound patterns of the starting sound patterns and (a1, b2) are selected as final ending candidate reference sound patterns of the ending sound patterns, it is determined whether or not any one of the final starting candidate reference sound patterns is the same as any one of the final ending candidate reference sound patterns.

When there is the same reference sound pattern (a1), the same reference sound pattern (a1) is determined to be a first final sound pattern. A subtracted image is generated by subtracting the first final sound pattern from the combined sound pattern of the collected sounds, and the database is searched for a reference sound pattern most similar to the subtracted image. When the most similar reference sound pattern (b1) is found, the most similar reference sound pattern (b1) is determined to be a second final sound pattern. Actions mapped to (a1, b1) are recognized as multiple user actions.

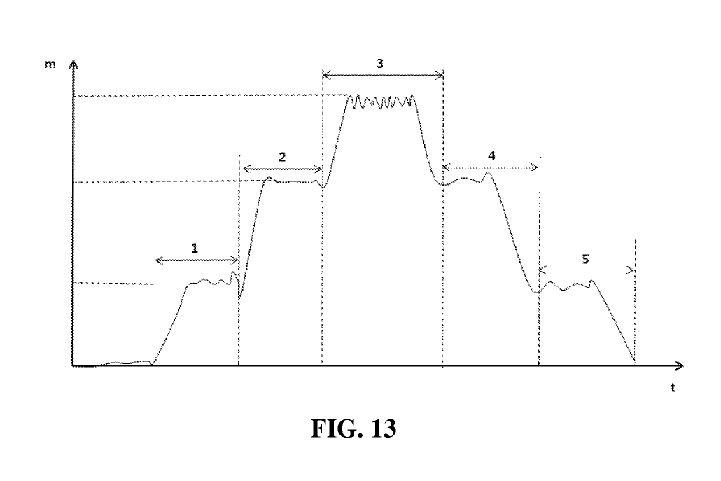

FIG. 13 is a graph illustrating an exemplary method of recognizing multiple user actions when collected sounds include sound patterns corresponding to three or more user actions.

Referring to FIG. 13, the collected sounds are recognized as including three or more user actions, based on the increasing zones of the collected sounds. The collected sounds are divided into unit increasing zones 1, 2, and 3 or unit decreasing zones 4 and 5.

First, reference sound patterns similar to the starting sound pattern are selected as first candidate reference sound patterns (a1, a2), and reference sound patterns similar to the ending sound pattern are selected as second candidate reference sound patterns (a1, c2). When any one of the second candidate reference sound patterns is the same as any one of the first candidate reference sound patterns, the same candidate reference sound pattern (a1) is determined to be a first final sound.

Reference sound patterns similar to subtracted sounds, produced by subtracting the first final sound (a1) from the unit increasing zone 2, are selected as third candidate reference sound patterns (b1, b2), while reference sound patterns similar to subtracted sounds, produced by subtracting the first final sound (a1) from the unit increasing zone 4, are selected as fourth candidate reference sound patterns (b1, d2). A subtracted image is produced by subtracting a combined sound, produced by combining a first final sound and a second final sound, from the unit increasing zone 3 corresponding to the combined sound pattern. The similarities between the subtracted image and the reference sound patterns are calculated, and a reference sound pattern having a highest similarity is selected as a third final sound.

Actions mapped to the first final sound, the second final sound, and the third final sound in the database are recognized as multiple user actions.

However, when none of the second reference sound patterns (c1, c2) is the same as any one of the first candidate reference sound patterns, reference sound patterns similar to subtracted sounds produced by subtracting any one of the first candidate reference sound patterns (a1, a2) from the unit increasing zone 2 are selected as third candidate reference sound patterns (b2, b3). In addition, reference sound patterns similar to subtracted sounds produced by subtracting any one of the second reference sound patterns (c1, c2) from the unit decreasing zone 4 are selected as fourth candidate reference sound patterns (d1, d2).

When any one of the third reference sound patterns is the same as any one of the fourth candidate reference sound patterns, the same candidate reference sound pattern is selected as a final sound as described above. However, when the same candidate reference sound pattern is not present, fifth candidate reference sound patterns (e1, e2) are selected by calculating the similarities between subtracted sounds and the reference sound patterns. Here, the subtracted sounds are produced by subtracting combined sounds, composed of a combination of the first candidate reference sound patterns and the third candidate reference sound patterns, from the unit increasing zone 3.

A final combined sound having a highest similarity is selected by comparing similarities between final combined sounds, respectively produced by combining one of the first candidate reference sound patterns, one of the third candidate reference sound patterns, and one of the fifth candidate reference sound patterns, and the collected sounds in the unit increasing zone 3. Actions corresponding to the first candidate reference sound pattern, the third candidate reference sound pattern, and the fifth candidate reference sound pattern of the final combined sound are recognized as multiple user actions.

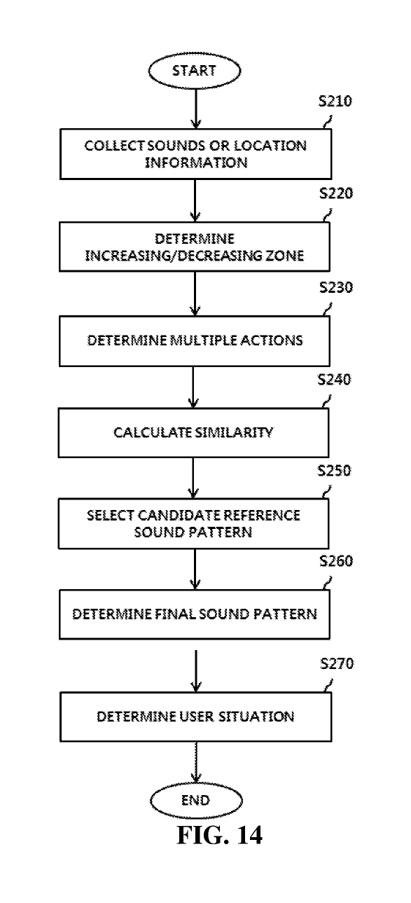

FIG. 14 is a flowchart illustrating a method of recognizing user situations according to the present disclosure.

Described in greater detail with reference to FIG. 14, step S210 of collecting sounds or place information, step S220 of determining an increasing zone or a decreasing zone, step S230 of determining the number of multiple actions, step S240 of calculating similarities, and step S250 of selecting candidate reference sound patterns are the same as the step S10 of collecting sounds or place information, step S20 of determining an increasing zone or a decreasing zone, step S30 of determining the number of multiple actions, step S40 of calculating similarities, and step S50 of selecting candidate reference sound patterns as described above with reference to FIG. 6, and detailed descriptions thereof will be omitted.

In S260, combined sound patterns generated from starting candidate reference sound patterns and ending candidate reference sound patterns are compared with the collected sounds, so that first final sound patterns and second final sound patterns, producing sounds collected from the starting candidate reference sound patterns or the ending candidate reference sound patterns, are determined.

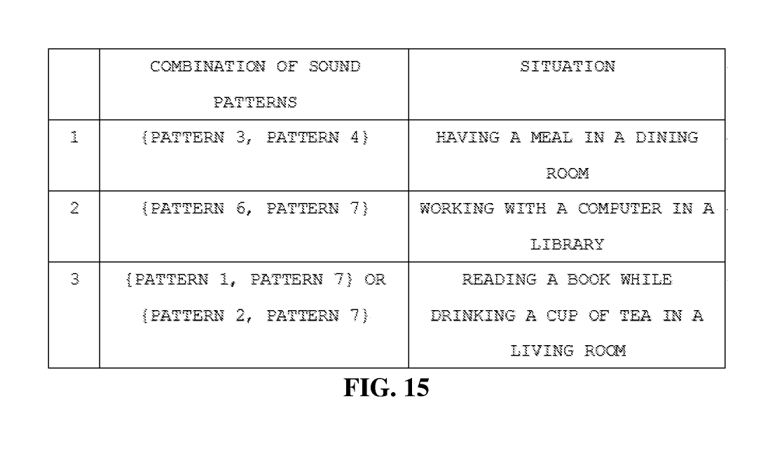

In S270, a user situation is determined based on combinations of sound patterns, generated from the first final sound patterns and the second final sound patterns, and user location information. Combinations of sound patterns and user situations corresponding and mapped to the combinations of sound patterns may be stored in the database. FIG. 15 illustrates an exemplary database containing combinations of sound patterns and user situations mapped to the combinations of sound patterns. When Pattern 3 and Pattern 4 are selected as a first final sound pattern and a second final sound pattern, situations mapped to Pattern 3 and Pattern 4 are recognized as user situations.

As described above, a plurality of final sound patterns of collected sounds are determined from the collected sounds. User actions are mapped to the final sound patterns. Since situations mapped to a combination of sound patterns consisting of a plurality of final sound patterns are recognized as user situations, a user situation corresponding to multiple user actions can be accurately determined.

The above-described embodiments of the present disclosure can be recorded as computer executable programs, and can be realized in a general purpose computer that executes the program using a computer readable recording medium.

Examples of the computer readable recording medium include a magnetic storage medium (e.g. A floppy disk or a hard disk), an optical recording medium (e.g. a compact disc read only memory (CD-ROM) or a digital versatile disc (DVD)), and a carrier wave (e.g. transmission through the Internet).

While the present disclosure has been described with reference to the certain exemplary embodiments shown in the drawings, these embodiments are illustrative only. Rather, it will be understood by a person skilled in the art that various modifications and equivalent other embodiments may be made therefrom. Therefore, the true scope of the present disclosure shall be defined by the concept of the appended claims.

1. A method of recognizing multiple user actions, the method comprising:
collecting sounds in a place in which a user is located;
calculating starting similarities between a starting sound pattern of the collected sounds and reference sound patterns stored in a database and ending similarities between an ending sound pattern of the collected sounds and the reference sound patterns stored in the database;
selecting starting candidate reference sound patterns and ending candidate reference sound patterns, same as the starting sound pattern and the ending sound pattern of the collected sounds, from among the reference sound patterns, based on the starting similarities and the ending similarities; and
recognizing multiple user actions based on the starting candidate reference sound patterns, the ending candidate reference sound patterns, and user location information.

2. The method according to claim 1, further comprising:
determining increasing zones, increasing by a size equal to or greater than a threshold size in the collected sounds; and
determining the number of multiple actions that produce the collected sounds, based on the number of the increasing zones.

3. The method according to claim 2, wherein selecting the starting candidate reference sound patterns and the ending candidate reference sound patterns comprises:
determining exclusive reference sound patterns, not occurring in the place, from among the starting candidate reference sound patterns or the ending candidate reference sound patterns, based on the user location information; and
determining final candidate reference sound patterns by removing the exclusive reference sound patterns from the starting candidate reference sound patterns or the ending candidate reference sound patterns,
wherein the multiple user actions are recognized based on the final candidate reference sound patterns and the user location information.

4. The method according to claim 3, wherein, when the number of the increasing zones or the decreasing zones is determined to be 2, recognizing the multiple user actions comprises:
generating a candidate combination sound by combining a single starting candidate reference sound pattern from among the final candidate reference sound patterns and a single ending candidate reference sound pattern from among the final candidate reference sound patterns;
determining a final candidate combination sound, most similar to the collected sounds, by comparing similarities between the candidate combination sound and the collected sounds; and
recognizing multiple actions mapped to the starting candidate reference sound pattern and the ending candidate reference sound pattern of the final candidate combination sound as the multiple user actions.

5. The method according to claim 3, wherein, when the number of the increasing zones is determined to be 2, recognizing the multiple user actions comprises:
determining whether or not a final candidate reference sound pattern from among the final candidate reference sound patterns of the starting candidate reference sound patterns is same as a final candidate reference sound pattern from among the final candidate reference sound patterns of the ending candidate reference sound patterns;
when the same final candidate reference sound pattern is present, determining the same final candidate reference sound pattern as a first final sound pattern;
determining a second final sound pattern by comparing similarities between subtracted sounds, produced by removing the first final sound pattern from the collected sounds, and the reference sound patterns stored in the database; and
recognizing actions mapped to the first final sound pattern and the second final sound pattern as the multiple user actions.

6. A method of recognizing multiple user actions, the method comprising:
collecting sounds in a place in which a user is located;
calculating starting similarities between a starting sound pattern of the collected sounds and reference sound patterns stored in a database and ending similarities between an ending sound pattern of the collected sounds and the reference sound patterns stored in the database;
determining starting candidate reference sound patterns, same as the starting sound pattern, from among the reference sound patterns, based on the starting similarities, and ending candidate reference sound patterns, same as the ending sound pattern, from among the reference sound patterns, based on the ending similarities;
determining whether or not a candidate reference sound pattern from among the starting candidate reference sound patterns is same as a candidate reference sound pattern from among the ending candidate reference sound patterns;
when the same candidate reference sound pattern is present, determining the same candidate reference sound pattern as a first final sound pattern and determining remaining final sound patterns using the first final sound pattern; and
recognizing user actions mapped to the first final sound pattern and the remaining final sound patterns as multiple user actions.

7. The method according to claim 6, further comprising:
determining increasing zones, increasing by a size equal to or greater than a threshold size, in the collected sounds; and
determining the number of multiple actions that produce the collected sounds, based on the number of the increasing zones.

8. The method according to claim 7, wherein, when the number of the increasing zones is determined to be 2, recognizing the multiple user actions comprises:
when the same candidate reference sound pattern is present, determining the same candidate reference sound pattern as the first final sound pattern;
determining a second final sound pattern by comparing similarities between subtracted sounds, produced by removing the first final sound pattern from the collected sounds, and the reference sound patterns stored in the database; and
recognizing actions mapped to the first final sound pattern and the second final sound pattern as the multiple user actions.

9. The method according to claim 7, wherein, when the same candidate reference sound pattern is not present and the number of the increasing zones is determined to be 2, recognizing the multiple user actions comprises:
generating a candidate combination sound by combining the starting candidate reference sound patterns and the ending candidate reference sound patterns;
determining a final candidate combination sound, most similar to the collected sounds, from among the candidate combination sound by comparing similarities between the candidate combination sound and the collected sounds; and
recognizing actions mapped to the starting candidate reference sound patterns and the ending candidate reference sound patterns of the final candidate combination sound as the multiple user actions.

10. The method according to claim 8, wherein determining the starting candidate reference sound patterns and the ending candidate reference sound patterns comprises:
determining exclusive reference sound patterns, not occurring in the place, from among the candidate reference sound patterns, based on the user location information; and
determining final candidate reference sound patterns by removing the exclusive reference sound patterns from the starting candidate reference sound patterns or the ending candidate reference sound patterns.

11. A method of determining a user situation, the method comprising:
collecting sounds and user location information in a place in which a user is located;
calculating starting similarities between a starting sound pattern of the collected sounds and reference sound patterns stored in a database and ending similarities between an ending sound pattern of the collected sounds and the reference sound patterns stored in the database;
selecting starting candidate reference sound patterns and ending candidate reference sound patterns, same as the starting sound pattern and the ending sound pattern, from among the reference sound patterns, based on the starting similarities and the ending similarities;
determining a first final sound pattern and a second final sound pattern, producing the collected sounds, from among the starting candidate reference sound patterns or the ending candidate reference sound patterns, by comparing combined sound patterns, produced from the starting candidate reference sound patterns and the ending candidate reference sound patterns, with the collected sounds; and
determining a user situation based on a combination of sound patterns, produced from the first final sound pattern and the second final sound pattern, and the user location information.

12. The method according to claim 11, further comprising:
determining increasing zones, increasing by a size equal to or greater than a threshold size, in the collected sounds; and
determining the number of multiple actions that produce the collected sounds, based on the number of the increasing zones.

13. The method according to claim 12, wherein selecting the starting candidate reference sound patterns and the ending candidate reference sound patterns comprises:
determining exclusive reference sound patterns, not occurring in the place, from among the starting candidate reference sound patterns or the ending candidate reference sound patterns, based on the user location information; and
removing the exclusive reference sound patterns from the starting candidate reference sound patterns or the ending candidate reference sound patterns.

14. The method according to claim 13, wherein, when the number of the increasing zones is determined to be 2, determining the user situation comprises:
generating a candidate combination sound by combining a single candidate reference sound pattern from among the starting candidate reference sound patterns and a single candidate reference sound pattern from among the ending candidate reference sound patterns;
determining a final candidate combination sound, most similar to the collected sounds, from the candidate combination sound by comparing similarities between the candidate combination sound and the collected sounds; and
determining the user situation based on the multiple actions corresponding to a combination of the first final sound pattern and the second final sound pattern of the final candidate combination sound.

15. The method according to claim 13, wherein, when the number of the increasing zones is determined to be 2, determining the user situation comprises:
determining whether or not a final candidate reference sound pattern from among the starting candidate reference sound patterns is same as a final candidate reference sound pattern from among the ending candidate reference sound patterns;
determining the same final candidate reference sound pattern as a first final sound pattern;
determining a second final sound pattern by comparing similarities between subtracted sounds, produced by removing the first final sound pattern from the collected sounds, and the reference sound patterns stored in the database; and
determining the user situation based on the multiple actions corresponding to a combination of the first final sound pattern and the second final sound pattern.

16. The method according to claim 9, wherein determining the starting candidate reference sound patterns and the ending candidate reference sound patterns comprises:
determining exclusive reference sound patterns, not occurring in the place, from among the candidate reference sound patterns, based on the user location information; and
determining final candidate reference sound patterns by removing the exclusive reference sound patterns from the starting candidate reference sound patterns or the ending candidate reference sound patterns.
